(19) United States
(12) Patent Application Publication
(10) Pub. No.: US 2009/0132969 A1
(43) Pub. Date: May 21, 2009

(54) METHOD AND SYSTEM FOR AUTOMATED INITIATION OF SEARCH QUERIES FROM COMPUTER DISPLAYED CONTENT

(76) Inventor: Ken Mayer, Los Angeles, CA (US)

Correspondence Address: HECKER & HARRIMAN, SUITE 2300, 1925 CENTURY PARK EAST, LOS ANGELES, CA, 90067, US

(21) Appl. No.: 11/917,245

(22) PCT Filed: May 5, 2006
(86) PCT No.: PCT/US2006/017532

§ 371 Date: Nov. 25, 2008

Related U.S. Application Data
(60) Provisional application No. 60/691,208, filed on Jun. 16, 2005.

(51) Int. Cl. G06F 3/048; G06F 7/06; G06F 17/30

(52) U.S. Cl. 715/862; 707/4; 715/764; 707/E17.108

(57) ABSTRACT

A method for generating search queries automatically from document text or other media objects based on a minimum of user interaction (FIG. 1) For each defined type of user input action there is a pre-determined search target The search target options are selected from a configured file An algorithm determines the search term and activates the search functionality as a result of the user's search A parsing engine matches the search target URL being queried

This application claims priority to U.S. Pat. App. No. 60/691,208 filed on Jun. 16, 2005, which is hereby incorporated by reference in its entirety.

### BACKGROUND AND SUMMARY OF THE INVENTION

Wide use of Internet search engines for locating information is now an accepted practice. With a growing number of users logging on to the Internet to obtain information from a growing number of Internet ready devices, the ease and simplicity of availability of searchable information is becoming a necessity. Internet users have a wide choice of search engines available at their disposal to locate required information. However, in the event Internet users see a term or object within a computer document (for example: webpage, email, instant message, video stream, mobile text, computer game, etc.) that they would like to perform an Internet search to retrieve information results for, there are still number of barriers and steps required from them to do so. First the user must be aware of the most appropriate search engine to search for the information they are seeking. Second the user must open a web browser window and/or access their desired information search source. Third the user must input the search term manually.

If users are reasonably savvy with computer interface they can avoid manually re-typing the term into the desired search engine if they are capable of performing the following user input action steps in order to issue the search request:

a) The user must select the keyword that they seek to search on;

b) The user must copy the keyword into the clipboard of the operating system interface, which is a temporary buffer where data can be stored;

c) The user must open new Internet browser window;

d) The user must navigate to the desired search engine;

e) The user must paste selected keyword into the entry field of the search engine webpage and then activate a go-button to initiate the search request.

This invention eliminates the need for these repetitive and time consuming steps by simplifying the process of searching on a word or phrase or object that appears in a document or video stream. By document, it is meant any kind of file that appears as text to the user, whether HTML, Java, digital video stream, word processing document, email, mobile SMS or MMS or any other kind of format where text or objects appears on a computer screen displayed to the user. The WordClick application can parse the text and, as a result of the application of heuristic rules, determine groups of words that are related. When the user selects a word on the screen, the entire group is selectable as a group to be input into a search engine as a query. This logic is an integral part of the WordClick application, in that it provides automation for the process of determining the search parameters the end user intends to utilize in a more efficient manner.

In another embodiment of the invention, it is possible to automatically select areas within the video stream and use them as search queries. It is currently possible to dynamically identify specific areas within digital video streams. This invention enables digital video viewers to retrieve search results by clicking in hotspots located within a specific region of a video steam viewing interface. A hotspot is an area of the computer screen display that is sensitive to a mouse click or other user input. Hotspots are typically revealed to the user by a cursor change, and when clicked will trigger another action. Technology for implementing so called ‘hot spots’ in digital video are known in the Windows programming art and are generally available as functions. More information can be found at “InfiniBand Architecture Specification vol. 1-Release 1.1” Nov. 6, 2002, InfiniBand Trade Association XP001191014 * p. 75, line 7-line 22 * p. 80, line 33-p. 82, line 30 * p. 464, line 40-line 42 * p. 555, line 18-line 21, which is incorporated herein by reference.

### SUMMARY OF THE INVENTION

It is therefore an object of the present invention to provide a method for searching for the selected term using a single step approach, whereby the selected term alone or grouped with another set of related terms in the same document are automatically converted into a search query submission to a search engine.

In order to achieve stated objective this invention consists of five sub-systems and sub-methods:

a. Text Capture Method

b. Word Set Method

c. Hover-Click Method

d. Multiple Search Targets System

e. Search Query Processor System

It is a further object of the present invention to provide text query generation for capturing text information from the third party application displaying the document without conventional programmatic interactions with the said application, that is, a series of laborious copying, launching and pasting into graphical user interface windows.

It is a further object of the present invention to automatically identify the full search query based on the single selected word and a context around it, referred to here in as the word-set method. Certain extensible logic or heuristic rules are used to determine the user's search intentions based on the single selected word and its context. Once the mouse cursor hovers over a word the application is not only identifying this particular word, but also considers the context the word is in. The invention analyzes whole paragraph or any other grouping of words that contain the word, and determines whether the word is a stand-alone query or, using the heuristics and logic rules, part of a word-set. If a word-set is identified, the application generates the search query using all of the words in the word-set. In addition, the invention highlights the words comprising the word-set, either using colors, underlining or any other typical text highlighting tool in order that the word-set is presented as a selectable item.

It is a further object of the present invention that the Hover-Click Method initiates action on the graphical user interface instead of requiring actuation of a physical switch, for example, the button on a computer interface mouse or touchpad. A main function of the invention is the ability to search for the word or set of words (keyword) in the most convenient way for the user. The invention provides logic that selects the simplest of all possible actions—mouse left-button click—to invoke its functionality. However, since mouse clicks are also used for a variety of other actions within the host application presenting the document, the hover-click method is used to distinguish actions directed toward the host application from those directed toward WordClick. The hover-click method initiates action as a result of the user hovering the cursor on the screen over the word, rather than requiring actuation of the button on the mouse or touch of a touchpad. The method works by the use of wait time. If the user is moving the cursor and clicking quickly, the hover-click application passes the clicks on to the hosted application. If the user pauses at a specific word for more than a pre-set amount of time, the hover-click method calls the word-set method based on that word and location. After the word-set is indicated, if the user moves the cursor away from the word and clicks, the hover-click method resets its state and passes that click on to the host application. This prevents un-intentional clicks to be passed to the WordClick application. After the word-set is indicated, if the user clicks on the same word, the WordClick application completes its functions. Typically, the word-set is assembled into a message packet and sent on to the search engine as a query. After the search query is sent, the program can reset its state.

It is a further object of the present invention to provide an interface to configure target search engines, referred to herein as Multiple Search Targets System. This aspect of the invention allows the application to adapt its function to the user's preferred search engine. Moreover, the application allows setting each user input combinations (such as Left-click, Left Double-click and Alt Left-click) to target a different search engine with the search query. The settings are kept locally within a configuration file, preferably encrypted, and are shipped with default, distributor-dependant values.

It is a further object of the present invention to provide Search Query Processor System to supply distributor identification information to the target search engine through the search query. This functionality permits the search engine to determine the source of the instance of the invention running on the user's computer. The purpose is that the search engine operator can then determine how to credit the initiation of the search. Practitioners of ordinary skill will recognize that search engines pay other websites on a per-referred search basis in order to steer search traffic from the website to the search engine. The invention's system inserts identifying information into the search query so that the search engine operator knows whether the instance of the invention is from one service or another and thus can accurately account for the search traffic.

### PRIOR ART

The patent prior art shows several attempts to create tools to assist the user in working with search engines. For example, U.S. Pat. No. 6,774,917, to Foote, et al, discloses a video searching method, but the method does not provide a way to use a video hotspot to get textual context and then use that text to generate a search. U.S. Pat. No. 6,862,710 to Marcisio discloses the notion of “soft links”, whereby any textual term within a document can be clicked upon. However, the patent does not provide a way to cause a search query generation, creation of a wordset or user interface actions that are distinct from clicking on a word within a document. The '710 describes a navigation process that uses a database to determine words related to that selected and lists of documents associated with each candidate related word. In contract, WordClick uses simpler heuristics within the document the user is looking at to create a web search engine query. In addition, the query immediately goes to a search engine without any intervening lexicographic database processing. U.S. Pat. No. 6,665,666 to Brown, et al, describes a method for answering natural language questions using a search engine. It does not generate search queries based on a selected word's context. Instead, the disclosure describes the notion of identifying the components of the question and assigning weights to different words within the provided question. U.S. Pat. No. 6,828,988 Hudson, et al. describes the use of a tooltip to assist the user in their editing. However, the patent claims focus on the use of a tooltip in a spreadsheet environment and specifically for helping the users with entering spreadsheet formulas. U.S. Pat. No. 6,848,077 to McBrearty describes the utilization of search engines to turn the user's pre-determined list of words of interest into hyperlinks, so that when the link is clicked, the search results are presented. In essence, it employs a search process before the hypertext document is loaded to create new links in a document, whereas the WordClick invention allows a user to select on any term in the document to initiate a word-set formation and search query. This approach requires the user to first input the words that are of interest before the HTML webpage is loaded. This is not how the typical user browses documents. The '077 invention requires that a user set up a configuration first before browsing documents. In this invention, WordClick uses the word-set invention to come up with search queries that are immediately acted upon without any pre-selection on the part of the user.

A number of commercial products have been deployed to attempt to simplify the search query process. First, the Google and Answers.com (formerly Ezula) provided a toolbar function. Each of these search toolbars allow users to (i) select text in a webpage (browser document) using the cursor, (ii) right click on this selected text, which displays the Windows context menu that has an option included to perform a search via their respective engines, (iii) single click on the option and have search results displayed in a new browser window. Unlike the invention at hand, the toolbar functionality requires that the user perform three input actions to cause the search results based on the text term in a computer document. This prior art system is not feasible for hardware that does not have a mouse (and therefore right click interface). The invention, on the other hand, allows for a single click or user action to cause the search, which includes the hover click methodology, extensible wordset formation logic and word capture technology. Furthermore, this approach does not generate search queries involving ‘objects’ in a computer document or video stream at all, as is the case with the this invention.

Microsoft introduced a product called “Smart Tags” in Office XP which provide an efficient way to perform certain actions that are associated with text in a computer document. For example, when a person's name appears in a Microsoft document, the text is transformed to indicate that it is recognized and when hovering over this area, a button appears alongside the selected text that provides a list of associated actions that the user can take. Currently, ‘search’ is not one of the default set of options within the Smart Tags. For Smart Tags to work, however, this requires that the text be recognized on input as having some kind of pre-determined attribute associated with the smart-tag.

The Smart Tags functionality is not initiated by the end user (e.g. by hovering over any text or object in a computer document). It does not include extensible word-set formation logic for ascertaining the search query the user desires based on the context of the document when a user places its cursor over a single area of the document or video stream. Smart-tags method instead uses a database of known keywords that are used to determine which terms are automatically activated in the document. Another difference is that there is no word capture logic or processes.

Answers Corporation released a product named “1-Click Answers,” which allows the user to use the left mouse button in conjunction with a configurable key to perform a search on text in most applications. The left mouse button may not be used alone but only in combination with another key such as the Alt key on Windows systems. The middle mouse button may be configured as a shortcut that does not require a concurrent key press. Unlike WordClick, there is no Word-Set formation logic and there is no feedback mechanism to indicate which word/words will be searched on. 1-Click Answers performs its own logic on the server to extract groups of words in phrases. This method bears no relationship to ours. Its server attempts to match the longest sequence of words with terms stored in a database and performs the search query on that.

In addition, none of these systems integrate an identification numbering system so that the search website operator can determine the origin of the copy of the computer application that caused the search query. Instead, the prior art envisions stand-alone applications.

### BRIEF DESCRIPTION OF THE DRAWINGS

FIG. 1 illustrates general architecture layout of WordClick application showing the major logical modules and briefly outlines their major responsibilities. WordCapture module contains Text Capture Method and Word-Set Method logic; Event Watcher contains Hover-Click Method logic; URL Processor module contains Search Query Processor System; Options UI/WordClick Dialog contains Multiple Search Targets System.

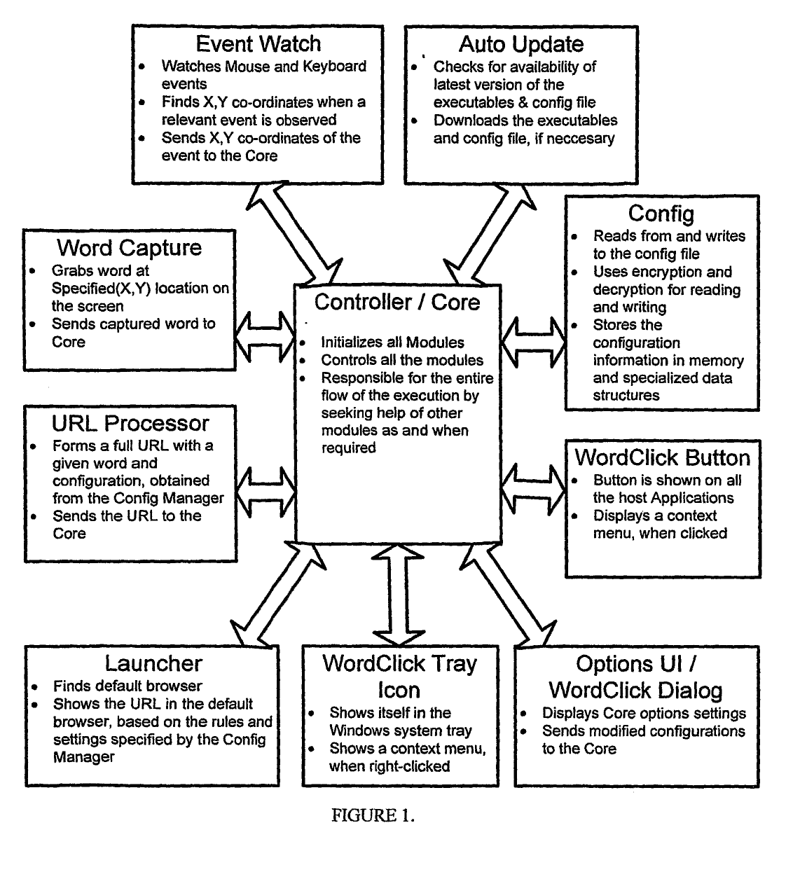

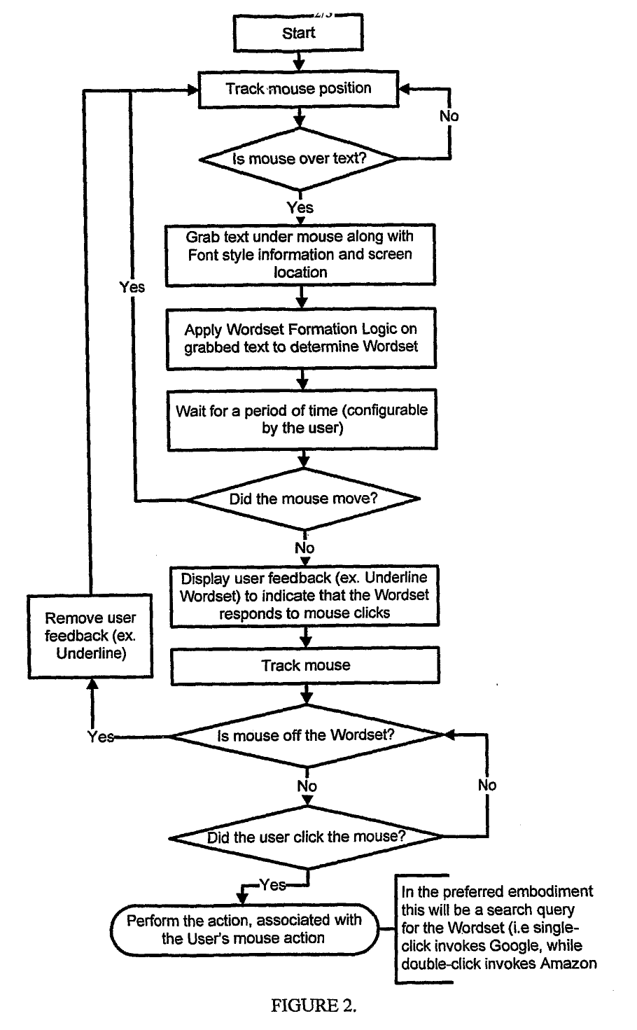

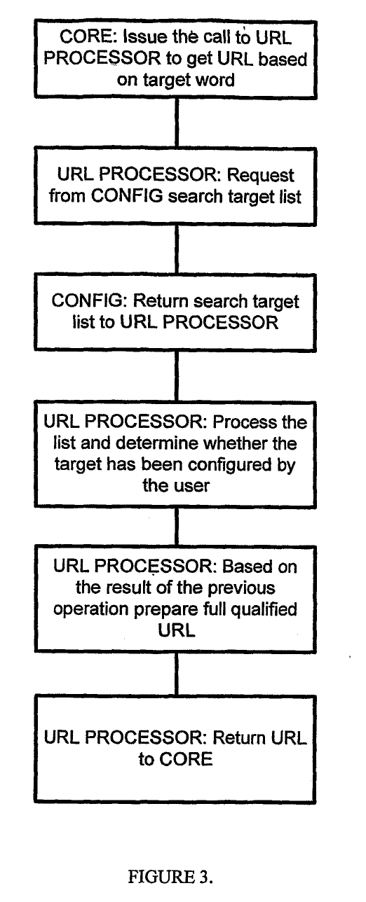

### DETAILED DESCRIPTION OF THE PREFERRED EMBODIMENTS

### Hover-Click Method for Selecting Words or Objects in the User Interface

The method of the present invention distinguishes among user mouse clicks to detect the ones with an intention to perform search query. Most personal computer interfaces, and now mobile devices including cell-phones, personal data assistants (PDA) present data to the user in the form of graphics on a screen. Typically, text is presented within a box, or window, which can be moved, expanded or contracted at will. Program interaction can also be actuated by means of displaying boxes on the screen with graphical elements that are buttons, sliders and other metaphors. The user selects these by moving the mouse, and hence moving the cursor on the screen to these locations and clicking one or more buttons on the mouse, which appear to actuate the buttons and sliders on the interface. This interactivity is well known in the art, as exemplified by Microsoft Windows™ and Apple Macintosh™ equipped computers.

It is a further object of the present invention to provide a method for intelligently distinguishing among mouse clicks and invoking search functionality only upon single-clicks with search user intentions. Practitioners of ordinary skill recognize that the mouse single left-button click is the simplest form of collecting input from the user. This invention aligns the most common user activity on the Internet—search for information—with the simplest form of user input. However, the single click is also used virtually by every computer application for a variety of purposes. Therefore, overlaying a program activated by mouse clicks on top of other application programs operating on text presents a problem: the application considers the mouse click to represent one action, while the invention would consider the mouse click to represent another. Therefore, it is an object of this invention to provide the user a way to distinguish between the two. This invention introduces a method to intelligently distinguish among mouse clicks the ones that are intended to initiate search queries and the ones that are not.

The method is performed by the computer when the computer user moves a mouse cursor over a word. Once the mouse movements are sufficiently minimized at a particular location on the screen, presumably over a word, the invention executes the Text Capture method explained below. In one embodiment, the invention process analyzes the mouse movement events and determines when the mouse movements stop for a pre-specified amount of time, typically a number of milliseconds. In the preferred embodiment the specified number is 500 milliseconds. However, WordClick application allows the user to adjust the value to their preference. Practitioners of ordinary skill recognize that it is customary practice to allow the user to adjust reaction values to their preference. Within Windows™ the majority of mouse click parameters, like double-click time period, mouse movement speed, etc. are settable through the user interface dialogs.

Text Capturing from Third Party Application Documents or Media Objects without Text Retrieval.

The typical computer application provides data retrieval services to a third party application displaying the document by means of using an Application Programming Interface (API) as a protocol for the running application. Through this API the third party application connects to the host application services and retrieves desired data from the application. This approach requires extensive programming and requires that a search generating program already have this interaction set up. In contrast, the WordClick invention provides a new method to capture text from the third party application without using an API. This is referred to as Text Capture.

Text Capture method of the present invention captures the text from the third party application and returns the text to the WordClick program that embodies the invention. The Text Capture method examines any third party application but does not require the application to be aware of it and provide text retrieval services. The method is performed by the computer when computer user moves a mouse cursor over a word. Practitioners of ordinary skill recognize that the mouse and cursor are common components of the user interface for a computer. The mouse translates physical movement by the hand into analogous movements on the computer screen. On the output the method gives the text paragraph, which contains the selected word under the mouse cursor, together with the paragraph metadata. Metadata consists of text font characteristics, which include following properties: font typeface, font size, font color, is text in Italics, is text in Bold, is text Underlined. The Text Capture method output associates text characteristics with the whole or part of the paragraph, since different words, or even different parts of the word, could possibly have different characteristics. The paragraph with the metadata is passed to WordClick application which invokes Word Set logic to construct the most appropriate search query based on the selected word and text context surrounding it.

In the preferred embodiment to capture the text under mouse cursor the method undertakes following steps:

a. Immediately after WordClick application is installed or at the computer with installed WordClick application startup time, WordClick application installs a system-wide hook to trap mouse events. Practitioners of ordinary skill recognize that Windows™ Operating System allows applications to install special procedures called “system-wide hooks” so that the application can be notified of a various system events. The preferred embodiment uses those hooks to be notified of mouse movement events.

b. In the preferred embodiment, the hover-click process is activated so that the system can distinguish between clicks directed to the host application and selections directed toward the invention. Practitioners of ordinary skill will recognize that the hover-click selection method can be replaced with typical mouse clicking selection in those areas where text is presented but there is no active clickable text.

c. Once the invention determines that a location has been selected, either by the hover-click method or an actual mouse click, the invention retrieves the selected object corresponding to where the mouse cursor is located using the Operating System services. Windows™ Accessibility API. Practitioners of ordinary skill recognize that the Windows™ Accessibility API is a set of services provided by Windows™ Operating System.

d. The preferred embodiment analyzes the type of the object and if it is a textual object determines the approximate bounding rectangle for the object.

e. Once the bounding rectangle is determined, the preferred embodiment installs additional hooks inside the application. Alternatively, these additional hooks can be established prior to the application launch, but activated at this step. These hooks target the text drawing functions and insert additional logic before executing the host application logic. The preferred embodiment uses the additional logic when those methods are executed in order that the invention capture the text and its properties.

f. After the hooks are installed, the preferred embodiment forces the application to repaint the object or re-display the object. During the repaint process, the host application uses the text output function to draw the text, which therefore, as a result of the installed hooks, causes a notification to be sent to the WordClick invention application with the text to be output and its properties. As a result, the invention receives the text from the selected area.

g. Once all text within bounding rectangle has been redrawn the preferred embodiment releases the text capture hooks, collects all of the text and its properties in a data structure and passes the text block as input into the Word Set method for producing the search query based on the local context the selected word is found in.

It is a further object of the present invention to provide a method for automatically identifying the full logical search query, which may consist of more than one word, based on the single selected word and a context around it. The invention provides a method to determine as close as possible to natural logic user's search intentions. Once a user selects a target word by moving the mouse cursor over it, the method analyzes the context in which the word is located and outputs the most appropriate set of words corresponding to the selected word within surrounding context. This output, or logical word set, is later sent to the search engine as a query.

The method of the present invention determines the most appropriate word-set corresponding to the selected word with the context. The method is performed by the computer when the computer user moves mouse cursor over a word. This method is invoked after Text Capture method collects the approximately local paragraph data from the third party application. As explained above, this module passes the text to the word set module. The word set module generates the query itself based on the local context. The query could consist of a single selected word or it could consist of multiple words all combined into the single query for the purposes of the search.

Word-Set Generation.

In the preferred embodiment, the computer loads logic rules from a configuration file and invokes the rule in order to create the search query. This allows for dynamic modifications to the logic rules and permits custom logic rules to be appended without general method modifications to the running application. In the preferred embodiment, the following parameters are passed from Text Capture method to the Word-Set method:

1) Selected word—the word over which mouse pointer is located.

2) Approximate paragraph which contains the selected word. All capitalization and punctuation within the paragraph is preserved.

3) Text characteristics of the paragraph, that is:
a. whether paragraph, or part there of, is in italics;
b. whether paragraph, or part there of, is in bold;
c. whether paragraph, or part there of, is underlined.

4) Font characteristics (typeface, size and color) of all elements within the paragraph.

Once all input for the method is collected, the method iterates through a chain of logic rules to determine the word-set that comprises the query. Logic rules are prioritized and are expandable. If the logic rule determines that the entire text block of input fits the criteria all subsequent logic rules are ignored. If the logic rule determines that input does not fit the criteria of that rule, next logic rule in the chain is invoked. If all logic rules fail to identify the term then the single selected word is output as the search term for this search.

In a preferred embodiment, the following are sample default logic rules, prioritized in the following order:

1) Italics logic rule:
a. The rule determines whether selected word is in italics;
b. If a. is satisfied, the rule determines whether surrounding words are in italics and counts number of words.
c. If the word count is more than pre-defined limit no term is selected and the next logic rule in the chain is invoked. If the word count is less than pre-defined limit all words in Italics are combined into the term. In the preferred embodiment, the pre-defined limit is six words.

2) Bolded logic rule:
a. The rule determines whether selected word is bolded;
b. If a. is satisfied, the rule determines whether surrounding words are bolded and counts number of words.
c. If the word count is more than pre-defined limit no term is selected and the next logic rule in the chain is invoked. If the word count is less than pre-defined limit all bolded words are combined into the term. In the preferred embodiment, the pre-defined limit is six words.

3) Underlined logic rule:
a. The rule determines whether selected word is underlined;
b. If a. is satisfied, the rule determines whether surrounding words are underlined and counts number of words.
c. If the word count is more than pre-defined limit no term is selected and the next logic rule in the chain is invoked. If the word count is less than pre-defined limit all underlined words are combined into the term. In the preferred embodiment, the pre-defined limit is six words.

4) Font characteristics logic rule:
a. The rule identifies font characteristics (typeface, size, color) of the selected word and its neighbors. Neighbors are considered words within same sentence and within pre-defined limit words from the selected word.
b. If all words within the neighborhood have the same font characteristics no term is selected and the next logic rule in the chain is invoked. If selected words has some font characteristics different from other words within neighborhood then all words with the same font characteristics as the selected word and adjacent to the selected word are combined into the term

5) Double-quotes logic rule:
a. The rule processes the paragraph to identify pairs of double-quotes and to determine whether the selected word is within double-quotes;
b. If a. is satisfied, the rule determines number of words within the quotes.
c. If the word count is more than pre-defined limit no term is selected and the next logic rule in the chain is invoked. If the word count is less than pre-defined limit all words within the quotes are combined into the term. In the preferred embodiment, the pre-defined limit is six words

6) Single-quotes logic rule:
a. The rule processes the paragraph to identify pairs of single-quotes and to determine whether the selected word is within single-quotes
b. If a. is satisfied, the rule determines number of words within the quotes
c. If the word count is more than pre-defined limit no term is selected and the next logic rule in the chain is invoked. If the word count is less than pre-defined limit all words within the quotes are combined into the term. In the preferred embodiment, the pre-defined limit is six words.

7) Capital Letters logic rule:
a. The rule identifies whether the selected word is capitalized;
b. If a. is satisfied, the rule collects all adjacent to the selected words which are capitalized and are within the same sentence counts the number of capitalized words. Special sub-rules are applied to the names as they could contain period, normally considered as a sentence terminator.
c. If the word count is more than pre-defined limit no term is selected and the next logic rule in the chain is invoked. If the word count is less than pre-defined limit all capitalized words are combined into the term. In the preferred embodiment, the pre-defined limit is six words.

The computer dynamically loads the logic rules from the configuration file without modifications to the system. Practitioners of ordinary skill will recognize that it is easy to append new rules to the method or to modify existing rules. A wide range of logic rules and additional Artificial Intelligence (AI) techniques may be used to select a query from a group of words as a result of selection of a single word in their midst. For example, a simple grammatical parser can be used to select the adjectives that modify a noun, a verb and its object or other grammatical relationships that are likely to be relevant as a query.

User Interface Actions Upon Query Generation:

When the Word Set query is generated, the invention then activates its own user interface instance on the screen in order to present to the user the selection that constitutes the query, that is, to identify to the user the word-set to be used as a search query and provides instructions to the user on how to initiate the query. The user interface is programmed to wait on the user selection to determine whether the user elects to proceed with the query.

The method attaches itself to the host application and injects itself in a critical place of the application, typically at the message queue, where all application input/output activity can be monitored. Once the method injects itself in this queue it analyzes every input host application activity to determine those actions which are of interest. To preserve host application functionality after analysis, most input messages are passed back to the host application intact. However, if the message is of interest to the method it is extracted from the message queue and set of instructions corresponding to the WordClick application are executed.

In the preferred embodiment following is the set of actions are performed in order to alert and prompt the user to a possible search query activity:

1. Immediately after Word Set method identifies the most appropriate search query from the selected word and the context it passes this data to the user interface.

2. This method identifies to the user the selected word set in a manner consistent with identifying link information in the host application. The preferred embodiment specifies that in a web browser (such as Internet Explorer™ or Firefox) selected words for the search query are identified the same way as a hyperlink is identified to the user. Practitioners of ordinary skill recognize that normally hyperlink is identified by underlying words in question; however this behavior is not standardized and differs from a variety of websites. Other kinds of indications can be used, for example, highlighting, bolding or presenting bounding boxes.

3. The method changes mouse cursor from the default one to the one used by the host application to identify the selectable word-set. Practitioners of ordinary skill recognize that normally the cursor changes from the arrow to the image of hand with an index finger pointing towards the link; however this behavior is not standardized and can differ in some applications while still providing the same selection functionality.

a. The method pops up on the user interface a ToolTip window with a descriptive message alerting the user to possible optional activity to search for identified words and providing instructions to the user how to do this. Practitioners of ordinary skill recognize that ToolTip is a standard element of the Windows™ Operating System and is used by a variety of applications to unobtrusively provide information to the user while the user operates an application.

b. Then the method waits for the user to either click on the identified word set or move the mouse pointer to a different position. In the preferred embodiment, the invention proceeds with the query if the user clicks on the identified word set. If the user moves the mouse away from the selected word-set, the invention determines that the user has not intended to search for the identified word set. Therefore all identification elements are removed and internal method state is reset to the original condition. Subsequent mouse clicks are processed as if the selection has not happened in the first place: the method examines them and passes back to the host application.

Multiple Search Targets for Configurable Search Target Options

It is a further object of the present invention to provide the user with options to send the selected word-set as a query to more than one search engines and allow the user to configure actual search engines to be used in the search. It is well known that search queries are submitted to search websites, like Google™, by means of opening a browser, passing control to the Google website, typing in the query words and selecting “go” on the user interface. Alternatively, the entire query can be assembled as a message packet containing the query words plus information about the source of the query, that is, the network address and process making the request. This message packet is sent to the website of the search engine using data networking protocol, typically the Internet with TCP/IP. Practitioners of ordinary skill will recognize that the invention can assemble these packets directly, without a browser interface, and send the search query as a message packet to the selected website.

Practitioners of ordinary skill recognize that in addition to the single left-mouse-button click there are number of other single-step options available to get the input from the user, like left-mouse-button double-click and left mouse-button single-click in combination with ALT keyboard key pressed. This invention uses additional single-step inputs from the user to search alternative search engines for the same word-set. Therefore, this invention provides a unique way to issue a search query to a range of search engines using a single-step approach.

The invention also specifies that target search engines can be configured dynamically by the user by means of a remote server. The server passes to the client application available choices of the search engines and default settings; while the users are able to configure target search engines and to assign click combinations to the search engine of their choice, default choices can be pre-configured.

When the invention user interface is invoked, after the word-set output has been produced, the user has multiple options to proceed, for example:
1. Left-mouse-button single-click.
2. Left-mouse-button double-click.
3. Left-mouse-button single-click with ALT keyboard key depressed at the same time.

The preferred embodiment specifies that each of this actions issue search request against different search engines. The preferred embodiment specifies that: in case of action (a) search query is issued against Google™ search engine; in case of action (b) search query is issued against Amazon™ search engine; in case of action (c) search query is issued against Frazoo™ search engine.

The preferred embodiment specifies that target search engines could be configured dynamically via following ways:

1. Dynamically delivered from the application server

2. Configured by the end user

In the preferred embodiment specifies that search engine configuration settings are kept in the separate configuration file and that the invention periodically checks WordClick server for software updates. In case the update is available, the application downloads and updates configuration file. This allows server to deliver new search targets and set default values for each of click combinations. In addition to server updates the preferred embodiment specifies that the application provides settings dialog box for search engines configuration. In this setting dialog the user can assign target search engine, out of the list of available search engines, to each particular click combination.

Software Distributor Identification Insertion in Search Query:

It is a further object of the present invention to dynamically pass distributor identification inside the search query. As the object of the present invention is to provide a method for searching for the selected term using a single step approach, it is essential to dynamically pass distributor identification inside the search query. Distributor identification is used by the invention to notify the target search engine of the search query origination. By origination, it is meant not just the address of the computer seeking the query result, but the identity associated with the instance of the invention residing on the computer. In this manner, the query can be associated by the search engine operator with the distributor of the specific copy of the software invoking the invention that is sending the query—as distinguished from the origination of the software itself. In other words, parties that distribute copies of the software can become associated with the search queries generated by those copies, even if the distributing party acquired the software from somewhere else.

Different search engines have different rules for passing distributor identification information; therefore this invention specifies how the invention application dynamically adjusts distributor information based on the rules of the target search engine. This method is typically executed after the word-set has been determined and before the search query is sent to the engine, however it can be performed at any time. The output of the method is that the search request message packet is sent to the specified search engine with the appropriate origination information appropriately inserted into the message packet.

In the preferred embodiment, the method of the present invention allows the application to dynamically insert distributor identification information inside the search query before it is sent to the target search engine. The preferred embodiment specifies that distributor information is kept in the configuration file together with the identity of the target search engines. Different formats of the distributor information are stored in the file, in a manner correlated with the different search engines. In this way, once the destination search engine is determined, the appropriately formatted origination data is retrieved from the file and inserted into the message packet comprising the search query. In the preferred embodiment, the information is encrypted and protected from user manipulation and tampering.

The preferred embodiment specifies that when the search query is ready to be sent to the search engine, the invention application inserts distributor information within the query, after the application of search engine input rules. This entails to appending a search engine specified keyword and a distributor identification pair, if appropriate at the end of the search query. The format of the distributor information is arbitrary and determined by the search engine. Following is a sample of a search query against Google™ Search engine with DID (identified by keyword sourceid appended and underlined): http://www.google.com/search?&q=WordClick&sourceid=4d825c90-9dbf-4dde-9bc1-d970807599f3

Detailed Description of the Distributor Identification Insertion Process

Each distributor of the software embodying the invention is assigned a unique identification number, or DID. The DID is used so that each query that is transmitted by the invention, embodied as WordClick, can identify itself to the destination search engine as a query resulting from WordClick or any entity that distributes WordClick. Therefore, if the WordClick program is distributed by two parties, with numbers 1 and 2, queries to the same search engine that have 1 or 2 in the appropriate field in the query are identifiable as being associated with one or the other party. This way, search engine companies can determine which of the two distributors should be credited for producing the search, from a monetary perspective. Practitioners of ordinary skill will recognize that many search engines, as businesses, are paid by advertisers based on traffic to the website. As a result, the search engine business pays other websites that steer search traffic to the search engine. Attribution is established by the inclusion of some indicia of identity in the query itself. In this case, the WordClick application, by means of the invention, can attribute the query submitted by the WordClick application to the distributor that installed or permitted the installation the application on the user's computer. By distributor, it is meant to include the website from which a copy of the application is downloaded, a party that authorizes the website to offer the download, a party that emails a copy of the program, a party that permits an upload of the program from their computer to be downloaded to another computer in the manner of a peer to peer connection, a party that combines one or more programs, including one embodying the invention, onto a computer readable medium including CD, DVD, USB key or any other memory device, authorizes the dublication of the medium and distribution of the medium, a party that while the program already resides in an deactivated state on a computer, causes the activation or installation of the program on the computer and a party that pre-loads software or authorizes the pre-loading of software onto a computer, All of these methods of promoting distribution of a computer program are considered distributors for the purpose of this disclosure. Any one of the parties can specify a unique attribution and modify the program embodying the invention (before or after distribution) so that the distributed copy of the program, when operated, includes in any search query message sent to a search engine website the attribution of the distributor.

The first step in this method is that a module called a “URL Processor” is invoked. The URL Processor is responsible for appending the DID for each supporting search engine target to the query string before it is sent. The URL Processor confirms that the proper DID is included in the URL query string and handles any special processing that may be required for the selected target search engine. In particular, the embodiment specifies that distributor information is kept in the configuration file. The URL Processor examines the configuration file to retrieve the appropriately formatted DID information based on the identity of the selected search engine target. The DID is integrated into the message packet that constitutes the submission of the query to the search engine by means of HTTP transmission over the Internet. Practitioners of ordinary skill will recognize that simple look-up methods can be used to perform the retrieval.

In the case of search targets that are configured by the end user, the URL Processor cross references the word-set query string with a search target list, and if a match is made, appends the DID to the query string before the HTTP message packet request is sent out to the search engine.

In the preferred embodiment, the URL Processor and its associated configuration file is secured from the possibility of end users changing the operations, settings or information contained in it; and be designed to prevent (as much as is possible) reverse engineering or other attempts to disable or reconfigure this module. This is accomplished by well known encryption and digital signing techniques. When created by the application, the configuration file is encrypted with a key, and when the application seeks information from the configuration file, the application can use the key to decrypt the configuration file. Practitioners of ordinary skill will recognize that many kinds of protocols to secure a file may be used.

The URL processor finishes assembling the query message packet by appending the appropriately formatted DID into the message. The message packet is then sent over the Internet to the search engine. As a result, the search engine can inspect the message packet and automatically determine which distributor the query should be attributed to. Alternatively, the query can be sent to a server under the control of the distributor or some other party, who logs an identity of the end-user, indicated by the HTTP source IP address, and then forwards on the search to the search engine.

### OTHER REFERENCES AND DESCRIPTIONS

The mouse: A mouse is a handheld pointing device for computers, involving a small object fitted with one or more buttons and shaped to sit naturally under the hand. The underside of the mouse houses a device that detects the mouse's motion relative to the flat surface on which it sits. The mouse's 2D motion is typically translated into the motion of a cursor on the display.

The hyperlink: A link in a document to information within that document or another document. These links are usually represented by highlighted words or images. When a reader selects a hyperlink, the computer display switches to the document or portion of the document referenced by the hyperlink.

Internet search technology: To request the electronic retrieval of documents based on the presence of specific terms and within other restrictions established (eg, subject, date, journal, etc.). Search results list a set of hyperlinks to documents retrieved as a result of a search request submitted. Major Internet Search Engines:
Google: finding web sites that match a user's query. Also includes Image Search, Local Search, Google News, and Froogle.
Yahoo: Yahoo! Internet portal provides email, news, shopping, web search, music, fantasy sports, and many other online products and services to consumers and businesses worldwide.
Open Directory Project: searchable Web directory compiled by volunteer editors

Pay Per Click technology: Pay per click, or PPC, is an advertising technique used on websites, especially search engines. Pay per click advertisements are usually text ads placed near search results; when a site visitor clicks on the advertisement, the advertiser is charged a small amount. Variants include pay for placement and pay for ranking. Pay per click is also sometimes known as Cost Per Click or CPC. Major Pay Per Click advertising engines:
Google AdWords: The Google Network reaches more than 80% of Internet users
Yahoo! Search Marketing (formerly Overture): Reaches more than 80% of active Internet users
Kanoodle.com: provider of cost-per-click sponsored links programs based on targeted search, content, and user behavior.

The described embodiments of the invention are intended to be exemplary and numerous variations and modifications will be apparent to those skilled in the art. All such variations and modifications are intended to be within the scope of the present invention as defined in the appended claims

Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The spirit and scope of the present invention are to be limited only by the terms of the appended claims. It should be noted that the flow diagrams are used herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention. Oftentimes, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Computer program logic implementing all or part of the functionality previously described herein may be embodied in various forms, including, but in no way limited to, a source code form, a computer executable form, and various intermediate forms (e.g., forms generated by an assembler, compiler, linker, or locator.) Source code may include a series of computer program instructions implemented in any of various programming languages (e.g., an object code, an assembly language, or a high-level language such as FORTRAN, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web.)

What is claimed:

1. A method executed by code running on a computer of generating a search query message packet using computer displayed text comprising:
Receiving from a user a selection of at least one word of the displayed text;
Determining a word-set comprised of at least one word of the displayed text;
Generating a digital network message packet comprised of an indicia of identity associated with one of the distributors of the copy of the program executing the method.

2. The method of claim 1 further comprising transmitting the message to a destination search engine website.

3. The method of claim 2 further comprising receiving from the user a selection of the identity of the search engine website that the transmitted message packet is sent to.

4. The method of claim 2 where the transmitting step is executed in response to the user actuating one of: a mouse click, a stylus touch, a button press, a voice command.

5. The method of claim 1 where the receiving step is comprised of detecting the condition where the user has not moved the cursor for a pre-determined period of time while it is in proximity to a word in proximity to the displayed text.

6. The method of claim 5 where the pre-determined period of time is less than 5 seconds.

7. The method of claim 1 further comprising displaying an indication of the members of the word-set in the displayed text.

8. The method of claim 7 where the word-set is comprised of less than 10 words.

9. The method of claim 1 where the word-set includes at least one word contextually related to the selected word.

10. The method of claim 1 where the determining step is comprised of applying at least one logic rule to a set of words in the text that includes the selected word.

11. The method of claim 10 where the logic rule is one of: italics logic rule, bolded logic rule, underlined logic rule, font type logic rule, double quote logic rule, single quote logic rule and capitalization logic rule.

12. The method of claim 9 further comprising modifying the order of logic rule application in response to pre-determined settings selected by the user.

13. The method of claim 2 where the transmitting step is to more than one search engine.

14. The method of claim 2 where the indicia of identity is a predetermined string associated with the identity of the distributor of the software.

15. The method of claim 14 further comprising:
Recovering the pre-determined string by one of decrypting or descrambling data read from a data storage device.

16. The method of claim 14 where the generating step is further comprised of
Receiving from the user a selection of the destination search engine website;
Retrieving the required attribution format associated with the selected destination search engine website;
Formatting the pre-determined string to comply with the required format.

17. A method executed by a first program on a computer also running a second program of determining a user's selection of an object displayed by the second program by means of a cursor comprising:
Trapping cursor movement data in order to determine the location of the cursor prior to the second program receiving the movement data;
Detecting the condition where the cursor has not been moved for a predetermined period of time;
Determining the stopped position of the cursor upon such detection;
Identifying at least one object displayed by the second program in proximity to the same location as the stopped position of the cursor.

18. The method of claim 17 where the predetermined period of time is less than 5 seconds.

19. The method of claim 17 where the at least one object is a text object.

20. The method of claim 19 where the text object is a word.

21. The method of claim 17 where the object is one of: an icon representing an image, an icon representing a television program, an icon representing a movie, an icon representing an audio signal, an icon representing a computer program.

22. Computer readable code embodied in computer-readable storage media that is configured to cause one or more processors to perform acts of: receiving from a user a selection of at least one word of the displayed text; determining a word-set comprised of at least one word of the displayed text; generating a digital network message packet comprised of an indicia of identity associated with one of the distributors of the copy of the program executing the method.

23. The computer readable code embodied in computer-readable storage media of claim 21, further comprising computer readable code configured to cause the one or more processors to perform acts including: transmitting the message to a destination search engine website.

24. The computer readable code embodied in computer-readable storage media of claim 22, further comprising computer readable code configured to cause the one or more processors to perform acts including: receiving from the user a selection of the identity of the search engine website that the transmitted message packet is sent to.

25. The computer readable code embodied in computer-readable storage media of claim 22, further comprising computer readable code configured to cause the one or more processors to perform acts including: displaying an indication of the members of the word-set in the displayed text.

26. The computer readable code embodied in computer-readable storage media of claim 21, where the act of determining is comprised of applying at least one logic rule to a set of words in the text that includes the selected word.

27. The computer readable code embodied in computer-readable storage media of claim 25, where the logic rule is one of: italics logic rule, bolded logic rule, underlined logic rule, font type logic rule, double quote logic rule, single quote logic rule and capitalization logic rule.

28. The computer readable code embodied in computer-readable storage media of claim 21, where the indicia of identity is a pre-determined string associated with the identity of the distributor of the software.

29. The computer readable code embodied in computer-readable storage media of claim 28, further comprising computer readable code configured to cause the one or more processors to perform acts including: Recovering the pre-determined string by one of decrypting or descrambling data read from a data storage device.

30. The computer readable code embodied in computer-readable storage media of claim 21, further comprising computer readable code configured to cause the one or more processors to perform acts including:
Receiving from the user a selection of the destination search engine website;
Retrieving the required attribution format associated with the selected destination search engine website;
Formatting the pre-determined string to comply with the required format.

31. Computer readable code embodied in computer-readable storage media that is configured to cause one or more processors running a first program displaying an object to perform acts of:
Trapping cursor movement data in order to determine the location of the cursor prior to the first program receiving the movement data;
Detecting the condition where the cursor has not been moved for a predetermined period of time;
Determining the approximate stopped position of the cursor upon such detection;
Identifying at least one object displayed by the first program in proximity to the same location as the stopped position of the cursor.
